(19) United States
(12) Patent Application Publication
(10) Pub. No.: US 2008/0253409 A1
(43) Pub. Date: Oct. 16, 2008

(54) Multi-Channel Bio-Chip Scanner

(76) Inventor: Woo-chul Moon, Seoul (KR)

Correspondence Address: LADAS & PARRY LLP, 224 SOUTH MICHIGAN AVENUE, SUITE 1600, CHICAGO, IL, 60604, US

(21) Appl. No.: 12/090,531

(22) PCT Filed: Mar. 16, 2006
(86) PCT No.: PCT/KR06/00949

§ 371 Date: Apr. 17, 2008

(30) Foreign Application Priority Data
Oct. 28, 2005 (KR) 10-2005-0102313

(51) Int. Cl. H01S 3/10; G01J 1/58; G06K 7/10

(52) U.S. Cl. 372/24; 250/459.1; 235/470

(57) ABSTRACT

There is provided a multi-channel bio-chip scanner using two or more excitation wavelengths. The bio-chip scanner includes: a glass holder unit mounted with a bio-chip in which a target DNA pre-marked by a fluorescent material is hybridized with a probe DNA; a light source unit irradiating a laser beam onto the bio-chip; a transfer unit transferring the bio-chip from the glass holder unit; and a detection unit detecting and analyzing fluorescent light expressed by the bio-chip with irradiation of the laser beam, wherein the light source unit generates two or more laser beams having different wavelengths.

### TECHNICAL FIELD

The present invention relates to a bio-chip scanner which analyzes a bio-chip by irradiating excitation light generated from a light source onto the bio-chip and detecting fluorescent light generated from the bio-chip, and more particularly, to a bio-chip scanner using a laser beam as the excitation light.

### BACKGROUND ART

A bio-chip is a small substrate made of glass, silicon, or nylon, on which biological molecules such as DNAs and proteins are integrated. Representative examples of the bio-chip includes a DNA chip in which DNA pieces (probe DNA) of which the base sequence is known are fixed at predetermined positions and a protein chip in which proteins such as enzyme or antibody/antigen are integrated. Such bio-chips are used in various fields such as gene/protein function analysis, new medicine development, animal and plant quarantine, forensic medicine, genetic variation search, drug susceptibility test, antibiotic resistance test, or germ search.

The bio-chips are analyzed by using an optical analysis method or an electrochemical analysis method. The optical analysis method is more commonly used in which a sample DNA (target DNA) sequence to be analyzed is coated with a fluorescent material responsive to a specific wavelength and then is hybridized with a probe DNA having a complementary base with respect to the target DNA. Then, the fluorescent material is excited with the excitation light having the specific wavelength and light having the specific wavelength emitted from the fluorescent material is detected. The optical analysis method uses the property that fluorescent material emits light having a wavelength longer than that of the excitation light when the internal energy of the fluorescent material is raised by receiving the light having the specific wavelength and then returns to a low energy level. The bio-chip scanner is used to irradiate the excitation light and to detect the emitted light.

FIG. 1 is a schematic diagram illustrating a conventional bio-chip scanner.

Referring to FIG. 1, the bio-chip scanner includes a glass holder unit 20 which is mounted with a bio-chip 10 in which a target DNA pre-marked with a fluorescent material is hybridized with a probe DNA, a light source unit 30 irradiating light to the target DNA on the bio-chip 10, a transfer unit 40 transferring the bio-chip 10 from the glass holder unit 20, and a detection unit 50 detecting light emitted from the fluorescent material and measuring a level of fluorescent expression by the DNA.

Such a bio-chip scanner is classified into two types depending upon kinds of a light source used in the light source unit 30: one type uses a white light source such as a xenon lamp or a metal halide lamp and the other type uses a laser such as a YAG laser or a He—Ne laser. The detection unit 50 includes a sensor for detecting the light emitted from the fluorescent material. The sensor may be an image pickup device such as a CCD (Charge Coupled Device) camera or a photomultiplier tube (PMT).

The bio-chip scanner using the white light should employ a color filter for transmitting only light of a specific wavelength so as to select only the light, of which wavelength is suitable for the fluorescent material to be detected, among the light emitted from the white light source, a refractive lens for controlling the excitation light so as to irradiate light with high intensity onto a wide area to be scanned, and an area sensor such as CCD for picking up an image. The conventional bio-chip scanner using the white light requires a large space, because it uses a lamp as the white light source. In addition, light efficiency deteriorates in practice, because only the light of the specific wavelength is selected. Further, to cool heat emitted from the lamp and to collect the light emitted from the lamp, a lot of additional devices are needed. Therefore, the weight of equipment is increased, and it takes much time to process and assemble the equipment. Accordingly, the bio-chip scanner using a laser is used more and more.

The conventional bio-chip scanner using a laser is of a one channel type using only one wavelength. The one-channel bio-chip scanner has various restrictions.

First, the one-channel bio-chip scanner can be used for only an On/Off chip. That is, it can be used for only a mutation search chip, a geno-typing chip, and an oligonucleotide chip having a genetic material of which the size is smaller than that of a cDNA chip.

Second, since a fluorescent material which must absorb light of a specific wavelength should be selected, the selection range of fluorescent materials is restricted. In addition, since it is difficult to acquire the fluorescent material with low cost, the saving of cost is restricted for manufacturing chips.

Third, it is also restricted to select the number of genes. In addition, principles used to install probes in a bio-chip and to make a reaction are restricted. Accordingly, development of a PCR kit used together with the bio-chip is also restricted.

### DISCLOSURE OF INVENTION

### Technical Problem

The present invention provides a multi-channel bio-chip scanner capable of overcoming the restrictions of the conventional one-channel bio-chip scanner.

### Technical Solution

According to an aspect of the present invention, there is provided a bio-chip scanner comprising: a glass holder unit mounted with a bio-chip in which a target DNA pre-marked by a fluorescent material is hybridized with a probe DNA; a light source unit irradiating a laser beam onto the bio-chip; a transfer unit transferring the bio-chip from the glass holder unit; and a detection unit detecting and analyzing fluorescent light expressed by the bio-chip with irradiation of the laser beam, wherein the light source unit generates two or more laser beams having different wavelengths.

In an exemplary embodiment of the invention, optical paths through which the laser beams having different wavelengths are incident onto the bio-chip from the light source unit may be equal to each other. In this case, the light source unit may further comprise a waveguide and/or a condenser lens in the optical paths through which the laser beams having different wavelengths are incident onto the bio-chip.

In an exemplary embodiment of the invention, the bio-chip scanner may further comprise a filter unit transmitting the fluorescent light having only a predetermined wavelength band.

In an exemplary embodiment of the invention, the light source unit may comprise two or more laser beam sources generating laser beams having different wavelengths, the two or more laser beam sources may be disposed in parallel on a panel, and the light source unit may further comprise one or more beam splitter and one or more reflection mirror in optical paths of the laser beams emitted from the two or more laser beam sources.

Specifically, the two or more laser beam sources may include a first laser beam source and a second laser beam source disposed beside the first laser beam source, the light source unit may further comprise a beam splitter in an optical path of a first laser beam emitted from the first laser beam source and a first reflection mirror directing a second laser beam toward the beam splitter in an optical path of the second laser beam emitted from the second laser beam source, and the first laser beam and the second laser beam, of which the optical paths have become equal to each other through the beam splitter, may be incident on the bio-chip. In this case, the light source unit may further comprise a waveguide and/or a condenser lens in the optical paths of the first and second laser beams, the optical paths having become equal to each other through the beam splitter.

More specifically, the first and second laser beam sources may emit the laser beams upwardly, the light source unit may further comprise a second reflection mirror directing the first and second laser beams, of which the optical paths have become equal to each other through the beam splitter, to left by a predetermined angle, for example, 90 degrees and a third reflection mirror directing the first and second laser beams, which have been directed by the second reflection mirror, to below by a pre-determined angle, for example, 90 degrees, the first and second laser beams having been directed by the third reflection mirror may pass through the waveguide, and the light source unit may further comprise a fourth reflection mirror directing the first and second laser beams having passed through the waveguide to the condenser lens.

### ADVANTAGEOUS EFFECTS

The bio-chip scanner according to the present invention is a multi-channel bio-chip scanner having two or more channels. Accordingly, the bio-chip scanner can be applied to chips associated with variation in medicine resistance and difference in expression between normal and abnormal genes.

The bio-chip scanner according to the invention can be applied to analysis of a protein chip, as well as an oligonucleotide chip and a cDNA chip.

In addition, since the bio-chip scanner according to the invention can use various fluorescent materials and low-cost fluorescent materials, it is possible to produce a low-cost chip.

Further, a variety of genes can be used in the bio-chip scanner according to the invention. Various principles such as SBH/mini-sequencing can be employed and various kinds of PCR kits can be developed.

Since the bio-chip scanner according to the invention can be constructed such that various laser beams pass through one optical path, it is possible to decrease the size and to save the cost. As for protein chips capable of providing important information for diagnosis of diseases, requirement for decrease in size of analysis instruments has been greatly increased so as to easily diagnose diseases in small hospitals and home. Accordingly, the bio-chip scanner according to the invention can be decreased in size, because it is of a multi-channel type but the entire size can be reduced.

By allowing the laser beams to pass through the waveguide and the condenser lens, it is possible to obtain high uniformity and to effectively condense the laser beams.

### DESCRIPTION OF DRAWINGS

The above and other features and advantages of the present invention will become more apparent by describing in detail exemplary embodiments thereof with reference to the attached drawings in which:

FIG. 1 is a schematic diagram illustrating a conventional bio-chip scanner;

FIG. 2 is a schematic diagram illustrating a bio-chip scanner according to a first embodiment of the present invention;

FIG. 3 is a diagram illustrating an example of a configuration of a light source unit in the bio-chip scanner according to the first embodiment of the present invention;

FIG. 4 is a schematic diagram illustrating a bio-chip scanner according to a second embodiment of the present invention; and

FIG. 5 is a diagram illustrating a configuration of a light source unit in a bio-chip scanner according to a third embodiment of the present invention.

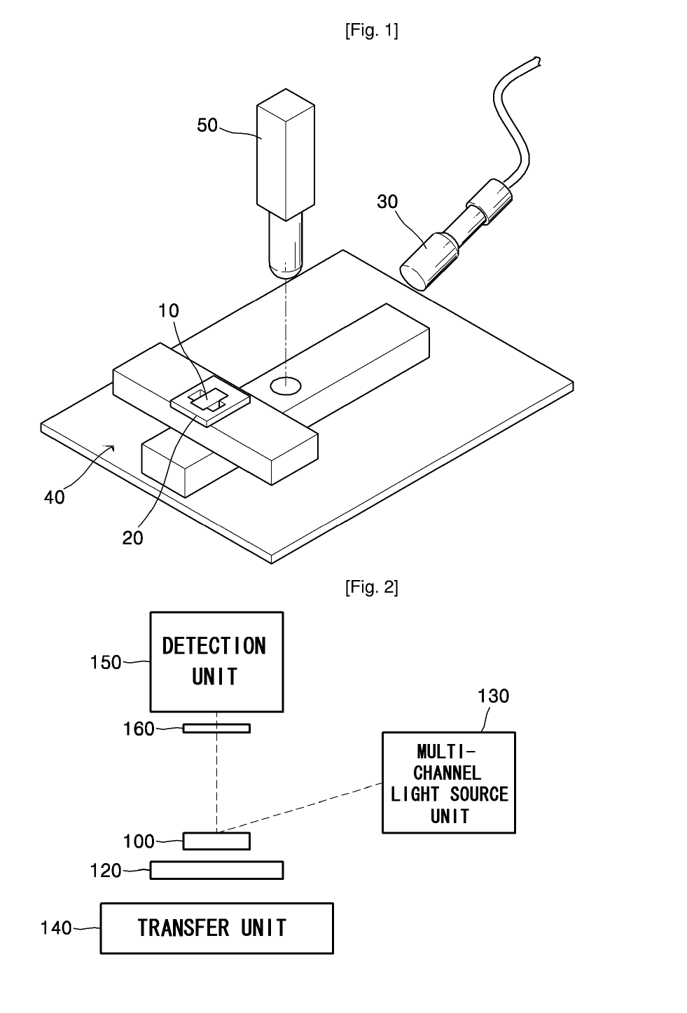

### MODE FOR INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

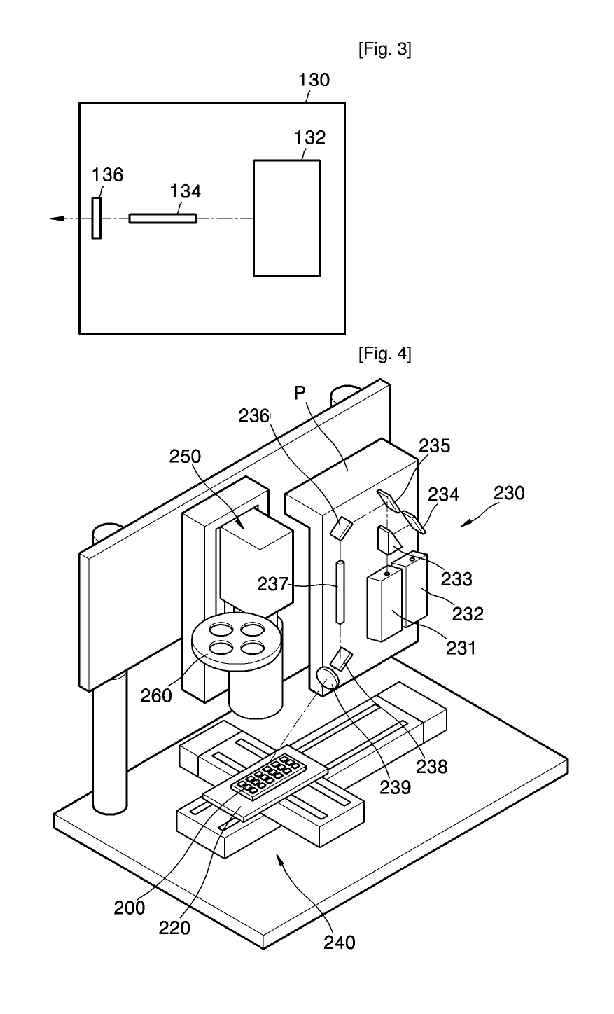

FIG. 2 shows a bio-chip scanner according to a first embodiment of the present invention and FIG. 3 schematically shows an example of a light source unit 130 shown in FIG. 2.

Referring to FIG. 2, the bio-chip scanner includes a glass holder unit 120 mounted with a bio-chip 100 in which a target DNA pre-marked with a fluorescent material is hybridized with a probe DNA, a light source unit 130 irradiating a laser beam onto the bio-chip 100, a transfer unit 140 transferring the bio-chip 100 from the glass holder unit 120, and a detection unit 150 detecting and analyzing fluorescent light expressed by the bio-chip 100 by irradiation of the laser beam. In an exemplary embodiment of the invention, the bio-chip scanner may further include a filter unit 160 transmitting only fluorescent light having a predetermined wavelength band among the fluorescent light expressed by the bio-chip 100.

The light source unit 130 is of a multi-channel type generating at least two laser beams having different wavelengths. Such a multi-channel bio-chip scanner having two or more excitation wavelengths can be used for chips associated with variation in medicine resistant and a difference in expression between normal and abnormal genes. In addition, the multi-channel bio-chip scanner can be also used for analysis of a protein chip, as well as an oligonucleotide chip and a cDNA chip. According to the present invention, since various fluorescent materials can be used and low-cost fluorescent materials can be used, it is possible to produce low-cost chips. In addition, a variety of genes can be applied to the multi-channel bio-chip scanner. It is possible to apply principles such as SBH/mini-sequencing in a variety of manners and to develop various kinds of PCR kits.

Referring to FIG. 3, the light source unit 130 generates two or more laser beams having different wavelengths. Optical paths through which the laser beams having two or more different wavelengths are incident onto the bio-chip from the light source unit 130 can be made equal to each other.

The light source unit 130 may include two or more laser beam sources as a laser beam source 132 so as to emit the laser beams having different wavelengths. As the laser beam source 132, a 488 nm laser can be used for performing measurement using FITC (Fluorescein IsoThioCyanate) is used as the fluorescent material and a 633 nm He—Ne laser or a laser diode can be used when APC (AlloPhyco-Cyanin) is used as the fluorescent material. The laser diode can be preferably used for the purpose of decrease in size.

As described later, the light source unit 130 may further include at least one beam splitter and at least one reflection mirror in the optical path of the laser beam so as to make equal to each other the optical paths through which the laser beams having different wavelengths are incident onto the bio-chip 100. Instead, the light source unit 130 may employ a wavelength variable laser as the laser beam source 132 so as to generate laser beams having different wavelengths. The laser beams having at least two different wavelengths can be irradiated onto the bio-chip 100 simultaneously or sequentially.

As described later, even when the number of laser beam sources are plural, it is possible to decrease the size of equipment and to reduce cost, by allowing the laser beams to pass through one optical path. For example, as for protein chips capable of providing important information for diagnosis of diseases, requirement for decrease in size of analysis instruments has been greatly increased so as to easily diagnose diseases in small hospitals and home. The bio-chip scanner according to the invention can be decreased in size, because it is of a multi-channel type but the entire size can be reduced.

As described above, the light source unit 130 may further include a waveguide 134 and/or a condenser lens 136 in the optical path through which the laser beams having different wavelengths are incident onto the bio-chip 100. High uniformity can be obtained by allowing the laser beams to pass through the waveguide 134 and the irradiated beams can be condensed effectively by allowing the laser beams to pass through the condenser lens 136.

FIG. 4 is a schematic diagram showing a bio-chip scanner according to a second embodiment of the invention.

As shown in FIG. 4, the bio-chip scanner according to the second embodiment includes a glass holder unit 220 mounted with a bio-chip 200 in which a target DNA pre-marked with a fluorescent material is hybridized with a probe DNA, a light source unit 230 irradiating a laser beam onto the bio-chip 200, a transfer unit 240 transferring the bio-chip 200 from the glass holder unit 220, and a detection unit 250 detecting and analyzing fluorescent light expressed by the bio-chip 200 by irradiation of the laser beam. In an exemplary embodiment of the invention, the bio-chip scanner may further include a filter unit 260 transmitting only fluorescent light having a predetermined wavelength band among the fluorescent light expressed by the bio-chip 200.

The detection unit 250 is disposed above the glass holder unit 220 and serves to detect the fluorescent light generated from the bio-chip 200 mounted on the glass holder unit 220. The light source unit 230 is disposed beside the detection unit 250 to be tilted toward the glass holder unit 220 and serves to irradiate excitation light to the bio-chip 200 fixed to the glass holder unit 220.

The light source unit 230 is of a multi-channel type generating at least two laser beams having different wavelengths. Advantages of the multi-channel type are as described already in the first embodiment.

In the second embodiment, the light source unit 230 includes at least two laser beam sources 231 and 232 generating laser beams having different wavelengths and the two laser beam sources 231 and 232 are disposed in parallel on a panel P. Optical paths through which the laser beams having different wavelengths are incident on the bio-chip 200 are made to be equal to each other by the use of at least one beam splitter 233 and at least one reflection mirror 234, 235, 236, or 238. Advantages of the case that the light source unit is of a multi-channel type but the optical paths are made to be equal to each other are as described already in the first embodiment.

Specifically, the at least two laser beam sources of the light source unit 230 generating the laser beams having different wavelengths include a first laser beam source 231 and a second laser beam source 232 disposed beside the first laser beam source 231. The light source unit 230 further includes a beam splitter 233 in the optical path of a first laser beam emitted from the first laser beam source 231. The light source 230 further includes a first reflection mirror 234 directing a second laser beam toward the beam splitter 233 in the optical path of the second laser beam emitted from the second laser beam source 232. In this way, the optical paths of the first laser beam and the second laser beam having passed through the beam splitter 233 are made to be equal to each other. The first laser beam and the second laser beam of which the optical paths have been made to be equal to each other can be irradiated onto the bio-chip 200 through a waveguide and/or a condenser lens, similarly to the first embodiment. Advantages of the case that the laser beams are allowed to pass through the waveguide and/or the condenser lens are as described in the first embodiment.

More specifically, the first and second laser beam sources 231 and 232 emit the laser beams upwardly. The light source unit 230 further includes a second reflection mirror 235 directing the first and second laser beams, of which the optical paths have become equal to each other by passing through the beam splitter 233, to left by a pre-determined angle, for example, 90 degrees and a third reflection mirror 236 directing the first and second laser beams, which have been directed by the second reflection mirror 235, to below by a predetermined angle, for example, 90 degrees. The first and second laser beams having been directed by the third reflection mirror 236 become more homogeneous while passing through the waveguide 237 and are reflected toward the condenser lens 239 by a fourth reflection mirror 238. The first and second laser beams are condensed by the condenser lens 239 and are irradiated onto the bio-chip 200.

An operation of analyzing the bio-chip 200 by the use of the bio-chip scanner will be described now.

In an experiment of a DNA chip, when the bio-chip 200 is a DNA chip, a cDNA prepared by reversely transcribing a DNA (single stranded DNA) fixed onto the chip and a mRNA to be analyzed is hybridized (complementary coupling principle of A=T and C=G) and then the amount of the mRNA is measured. The enzyme reaction or the experiment work is similar to that of the existing experiment method. However, compared with the existing experiment work used in hybridization, since a very small amount (10 to 100 ml) of reaction solution is used and the amount of DNA fixed onto the DNA chip is also very small (several tens pL), variation in distribution of a DNA quantity is very large, thereby requiring a data processing operation for correcting the variation.

Generally, in the experiment of the DNA chip, an RNA sample to be controlled and an RNA sample to be tested are reversely transcribed and marked with fluorescent materials, respectively, for comparison of experimental data. The fluorescent material used for analysis of the DNA chip is dUTP in which Cy3™ and Cy5™ are coupled and is marked on the cDNA with almost the same efficiency. Since the absorption wavelength and the fluorescent wavelength of the fluorescent material are different from each other, the intensities of the fluorescent light can be measured. He—Ne lasers having excitation wavelengths of 543 nm and 633 nm are used as the first and second laser beam sources 231 and 232, respectively. Cy3™ has an absorption wavelength of 550 nm and a fluorescence wavelength of 570 nm and Cy5™ has an absorption wavelength of 649 nm and a fluorescence wavelength of 670 nm.

The bio-chip 200 is transferred to a portion where the light source unit 230 and the detection unit 250 are disposed by the transfer unit 240. The laser beam generated from the first or second laser beam source 231 or 232 is irradiated onto the bio-chip 200.

The filter unit 260 transmits only the fluorescent light having a specific wavelength band among the fluorescent light emitted from the fluorescent material of a target bio element on the bio-chip 200. Here, the wavelength band of the light filtered by the filter unit 260 is an emission wavelength band of the fluorescent material. As shown in FIG. 4, the filter unit 260 includes a circular plate-shaped filter wheel and a plurality of openings formed in the filter wheel. Emission filters are respectively placed in the openings such that desired emission filters can be selected while rotating about the center axis.

The detection unit 250 detects the fluorescent light emitted from the bio-chip 200 and forms an image. A photomultiplier tube (PMT) or a CCD camera can be used in the detection unit 250. The CCD camera a linear image pickup element and an area image pickup element such as TDI (Time Delayed Integration) sensor. By moving the transfer unit 240 while photographing very small portions so as to acquire an image with a high resolution, an image of the entire bio-chip 200. The acquired image is read by an image processing reader of the detection unit 250, thereby performing diagnosis of diseases or the like.

The fluorescent intensities of Cy3™ and Cy5™ are acquired in the form of image data from the bio-chip 200 by the use of a DNA chip analyzer and then are numerically expressed by the use of DNA chip analysis software. A DNA expression ratio (mRNA quantity) can be visually expressed in various ways such as a scatter plot, a circular graph, or an image overlap by the use of the analysis software. Further, numeric values of signal intensities of Cy3™ and Cy5™ can be normalized by the use of various parameters.

The bio-chip 200 having been subjected to the detection of the detection unit 250 is transferred to a predetermined position by the transfer unit 240 and then is detached from the glass holder unit 220.

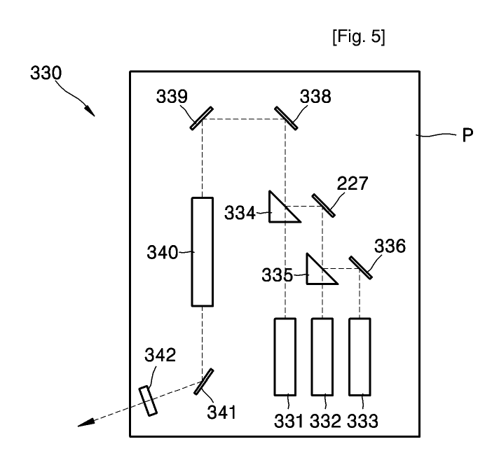

FIG. 5 is a schematic diagram illustrating a configuration of a light source unit of a bio-chip scanner according to a third embodiment of the present invention, where the bio-chip scanner is a three-channel bio-chip scanner employing three laser beams having different wavelengths.

In the second embodiment described above, the two-channel bio-chip scanner is constructed by the use of two laser beam sources, one beam splitter, and four reflection mirrors. In this way, by using laser beams sources, beam splitters, and reflection mirrors, three or more channels can be embodied.

An example thereof is shown in FIG. 5. Referring to FIG. 5, the light source unit 330 includes first to third laser beam sources 331, 332, and 333 generating laser beams having different wavelengths. The first to third laser beam sources 331, 332, and 333 are disposed in parallel on a panel P. The first to third laser beam sources 331, 332, and 333 emit the laser beams upwardly.

The light source unit 330 further includes a first beam splitter 334 in the optical path of a first laser beam emitted from the first laser beam source 331 and a second beam splitter 335 in the optical path of a second laser beam emitted from the second laser beam source 332. The light source unit 330 further includes a first reflection mirror 336 directing a third laser beam emitted from the third laser beam source 333 toward the second beam splitter 335 in the optical path of the third laser beam. In this way, the optical paths of the second laser beam and the third laser beam having passed through the second beam splitter 335 become equal to each other. The second laser beam and the third laser beam of which the optical paths have become equal to each other are directed to the first beam splitter 334 by the second reflection mirror 337. As a result, the optical paths of the first, second, and third laser beams having passed through the first beam splitter 334 become equal to each other. Similarly to the embodiments described above, the first to third laser beams may be irradiated onto a bio-chip (not shown) through a waveguide 340 and/or a condenser lens 342. Reference numerals 338, 339, and 341 denote reflection mirrors reflecting the first to third laser beams to change the optical paths by predetermined angles, respectively.

By combination of the embodiments described above, bio-chip scanners having four or more channels and optical paths having become equal to each other can be embodied.

Although the present invention has been particularly shown and described with reference to the exemplary embodiments thereof, it will be understood by those skilled in the art that various changes in form and details may be made therein without departing from the spirit and scope of the invention as defined by the appended claims.

1. A bio-chip scanner comprising:
a glass holder unit mounted with a bio-chip in which a target DNA pre-marked with a fluorescent material is hybridized with a probe DNA;
a light source unit irradiating a laser beam onto the bio-chip;
a transfer unit transferring the bio-chip from the glass holder unit; and
a detection unit detecting and analyzing fluorescent light expressed by the bio-chip by irradiation of the laser beam,
wherein the light source unit generates two or more laser beams having different wavelengths.

2. The bio-chip scanner according to claim 1, wherein optical paths through which the laser beams having different wavelengths are incident onto the bio-chip from the light source unit are equal to each other.

3. The bio-chip scanner according to claim 2, wherein the light source unit further comprises a waveguide in the optical paths through which the laser beams having different wavelengths are incident onto the bio-chip.

4. The bio-chip scanner according to claim 2, wherein the light source unit further includes a condenser lens in the optical path through which the laser beams having different wavelengths are incident onto the bio-chip.

5. The bio-chip scanner according to claim 3, wherein the light source unit further includes a condenser lens in the optical path through which the laser beams having different wavelengths are incident onto the bio-chip.

6. The bio-chip scanner according to claim 1, further comprising a filter unit transmitting the fluorescent light having only a predetermined wavelength band.

7. The bio-chip scanner according to claim 1, wherein the detection unit is disposed above the glass holder unit, the light source unit is disposed beside the detection unit so as to be tilted toward the glass holder unit, the light source unit comprises two or more laser beam sources generating laser beams having different wavelengths, the two or more laser beam sources are disposed in parallel on a panel, and the light source unit further comprises one or more beam splitter and one or more reflection mirror in optical paths of the laser beams emitted from the two or more laser beam sources.

8. The bio-chip scanner according to claim 7, wherein the two or more laser beam sources include a first laser beam source and a second laser beam source disposed beside the first laser beam source, the light source unit further comprises a beam splitter in an optical path of a first laser beam emitted from the first laser beam source and a first reflection mirror directing a second laser beam toward the beam splitter in an optical path of the second laser beam emitted from the second laser beam source, and the first laser beam and the second laser beam, of which the optical paths have become equal to each other through the beam splitter, are incident on the bio-chip.

9. The bio-chip scanner according to claim 8, wherein the light source unit further comprises a waveguide in the optical paths of the first and second laser beams, the optical paths having become equal to each other through the beam splitter.

10. The bio-chip scanner according to claim 8, wherein the light source unit further comprises a condenser lens in the optical paths of the first and second laser beams, the optical paths having become equal to each other through the beam splitter.

11. The bio-chip scanner according to claim 9, wherein the light source unit further comprises a condenser lens in the optical paths of the first and second laser beams, the optical paths having become equal to each other through the beam splitter.

12. The bio-chip scanner according to claim 11, wherein the first and second laser beam sources emit the laser beams upwardly, the light source unit further comprises a second reflection mirror directing the first and second laser beams, of which the optical paths have become equal to each other through the beam splitter, to left by 90 degrees and a third reflection mirror directing the first and second laser beams, which have been directed by the second reflection mirror, to below by 90 degrees, the first and second laser beams having been directed by the third reflection mirror pass through the waveguide, and the light source unit further comprises a fourth reflection mirror directing the first and second laser beams having passed through the waveguide to the condenser lens.

13. The bio-chip scanner according to claim 2, wherein the detection unit is disposed above the glass holder unit, the light source unit is disposed beside the detection unit so as to be tilted toward the glass holder unit, the light source unit comprises two or more laser beam sources generating laser beams having different wavelengths, the two or more laser beam sources are disposed in parallel on a panel, and the light source unit further comprises one or more beam splitter and one or more reflection mirror in optical paths of the laser beams emitted from the two or more laser beam sources.

14. The bio-chip scanner according to claim 13, wherein the two or more laser beam sources include a first laser beam source and a second laser beam source disp osed beside the first laser beam source, the light source unit further comprises a beam splitter in an optical path of a first laser beam emitted from the first laser beam source and a first reflection mirror directing a second laser beam toward the beam splitter in an optical path of the second laser beam emitted from the second laser beam source, and the first laser beam and the second laser beam, of which the optical paths have become equal to each other through the beam splitter, are incident on the bio-chip.

15. The bio-chip scanner according to claim 14, wherein the light source unit further comprises a waveguide in the optical paths of the first and second laser beams, the optical paths having become equal to each other through the beam splitter.

16. The bio-chip scanner according to claim 14, wherein the light source unit further comprises a condenser lens in the optical paths of the first and second laser beams, the optical paths having become equal to each other through the beam splitter.

17. The bio-chip scanner according to claim 15, wherein the light source unit further comprises a condenser lens in the optical paths of the first and second laser beams, the optical paths having become equal to each other through the beam splitter.

18. The bio-chip scanner according to claim 17, wherein the first and second laser beam sources emit the laser beams upwardly, the light source unit further comprises a second reflection mirror directing the first and second laser beams, of which the optical paths have become equal to each other through the beam splitter, to left by 90 degrees and a third reflection mirror directing the first and second laser beams, which have been directed by the second reflection mirror, to below by 90 degrees, the first and second laser beams having been directed by the third reflection mirror pass through the waveguide, and the light source unit further comprises a fourth reflection mirror directing the first and second laser beams having passed through the waveguide to the condenser lens.
